(19) United States
(12) Patent Application Publication
(10) Pub. No.: US 2012/0156051 A1
(43) Pub. Date: Jun. 21, 2012

(54) WIND TURBINE BLADE

(75) Inventor: Peter GRABAU, Kolding (DK)

(73) Assignee: ENVISION ENERGY (DENMARK) APS, Silkeborg (DK)

(21) Appl. No.: 13/333,116

(22) Filed: Dec. 21, 2011

(30) Foreign Application Priority Data
Dec. 21, 2010 (DK) PA 2010 70569

(51) Int. Cl. F03D 1/06

(52) U.S. Cl. 416/235

(57) ABSTRACT

A wind turbine blade is described wherein the blade comprises a hinged flap provided at the leading edge of the blade. The flap is arranged to hinge when the angle of attack of the incident airflow falls below a pre-defined angle, so that the aerodynamic profile of the blade is altered to reduce the magnitude of the negative lift coefficient of the blade. This reduces strain on the blade in such conditions, and associated fatigue loads on the blade and the wind turbine structure. The flap utilises simple biasing means, and does not require complicated sensor or actuation systems.

### BACKGROUND OF THE INVENTION

1. Field of the Invention

The present invention relates to a wind turbine blade, in particular a wind turbine blade adapted to reduce fatigue loads.

2. Description of Related Art

With reference to FIG. 1, a standard wind turbine blade airfoil profile is indicated generally at 10. The wind turbine blade 10 has a leading edge 12 facing the incident wind and an opposed trailing edge 14. In normal operation, the upper surface of the blade 10 is referred to as the suction side 16 and the lower surface is referred to as the pressure side 18, referring to the respective low and high pressure areas provided at either side of the airfoil. The chord of a wind turbine blade is an imaginary straight line joining the trailing edge 14 and the centre of curvature of the leading edge 12 of the blade cross-section, indicated here at 20.

In wind turbine blades, the angle of attack refers to the angle between the chord line 20 of the blade airfoil profile 10 and the direction of the incident wind. A positive angle of attack is when the incident airflow makes an angle between the chord 20 of the blade 10 and the lower surface 18 of the blade 10, as indicated by the arrow marked A. A negative angle of attack is when the incident airflow makes an angle between the chord 20 of the blade 10 and the upper surface 16 of the blade 10, as indicated by the arrow marked B.

Lift coefficient (C_{L}) is often used as a way of characterising a particular wind turbine airfoil shape. The lift coefficient is a dimensionless number used to relate the total lift generated by an airfoil to the total area of the airfoil. It is given by the formula:

$${C}_{L} = \frac{L}{1 / 2 ρ {v}^{2} A}$$

where L is lift force, ρ is fluid density, ν is true airspeed, and A is airfoil area. The lift coefficient varies with the angle of attack, as well as with the shape of the airfoil in question (e.g. if a wind turbine blade transitions between different airfoil profiles along its length, then the lift coefficient for that blade will vary dependent on the location along the blade length). The lift coefficient can be used to describe the characteristics of the airfoil, and is usually derived for a particular airfoil after wind tunnel testing.

With reference to FIG. 2, a sample lift coefficient curve is shown, plotting the lift coefficient (C(Lift)) against the angle of attack (AoA) of the incident airflow for a particular airfoil aerodynamic profile (or cross-section). The upper peak 100 of the lift coefficient is the angle of incident airflow at which the airfoil generated maximum lift. Beyond this peak, the airfoil will go into a stall condition. The lower peak 102 of the curve shows the maximum negative lift coefficient for the airfoil, which is the negative lift which the airfoil experiences when the angle of attack is a negative angle (i.e. from a direction above the chord of the airfoil).

One important consideration for wind turbine blade design is the stresses and strains which can be produced by fatigue loads. Fatigue loads can be caused when a blade experiences rapidly changing wind conditions, e.g. gusts. Such gusts of wind may result in the incident airflow at the wind turbine blade changing from a positive angle of attack to a negative angle of attack, or vice versa, within a short period of time. Thus, sections of the blade (or even substantially the entire blade length) may undergo changes in lift generation from positive to negative lift very rapidly (e.g. with reference to FIG. 2, from the upper peak 100 to the lower peak 102). Such changing lift forces result in fatigue loads being generated both within the blade, and between the blade and the remainder of the wind turbine structure.

EP 2 098 721 A2 discloses the use of projections on the pressure side of a wind turbine blade to alter the aerodynamic profile of the blade and thus reduce the effects of fatigue loads. The projections may be provided in the form of permanent alterations to the profile of a wind turbine blade, or actuatable projections. The permanent alteration option involves the use of permanent projection strips which are often fixed and immovable, thus affecting the overall aerodynamic performance of the blade in all conditions. The use of actuatable projections requires that such blades comprise relatively complex control and actuation systems. Furthermore, the design and weight of such blades may become compromised due to the increased weight involved in accommodating such systems.

### SUMMARY OF THE INVENTION

It is an object of the invention to provide a wind turbine blade which aims to reduce the damaging effects of stall conditions and fatigue loads, with reduced cost and complexity.

Accordingly, there is provided a wind turbine blade having an aerodynamic profile, the blade comprising a blade body having a leading edge and a trailing edge, the blade further comprising at least one passively hinged flap provided along a section of said leading edge, said flap arranged to hinge from a first position, wherein said flap is positioned adjacent the surface of said blade body, to a second position, wherein said flap projects from said blade body, wherein said at least one flap is arranged such that when in said second position said flap is operable to reduce the magnitude of the negative lift coefficient of the wind turbine blade at said at least one flap.

Effectively, when the flap is in said first position, the wind turbine blade has a first aerodynamic profile, and when the flap is in said second position, the wind turbine blade has a second aerodynamic profile, wherein the magnitude of the negative lift coefficient of said second aerodynamic profile is smaller than the magnitude of the negative lift coefficient of the first aerodynamic profile. As the flap acts to reduce the negative lift coefficient of the blade, accordingly the magnitude of any fatigue loads experienced by the wind turbine blade will be reduced, leading to less stresses and strains induced in the wind turbine structure. This provides for a longer component life and improved reliability. The use of a simple hinged flap means that the weight of the blade is not seriously compromised, and the aerodynamic profile of the blade is not substantially affected by the flap when in the first, closed, position. The use of a flap having a passive hinge means that the flap is not powered and/or does not required a complicated control mechanism.

Preferably, said at least one flap is actuated to move from said first position to said second position by the force of the air pressure of the incident airflow at said at least one flap.

As a wind turbine blade experiences changing wind conditions, the location of the suction and pressure forces normally found for an airfoil profile can change orientation. As the flap is positioned at the leading edge of the wind turbine blade, it experiences these changes in orientation between the suction side and the pressure side of the blade profile, as the angle of attack of incident airflow changes. The flap is positioned and arranged such that the suction force of the incident airflow about the airfoil profile opens the flap to the second position. As the flap is effectively actuated by the surrounding air pressure, accordingly there is no need for relatively complicated actuation devices to operate the flap.

Preferably, said at least one flap is arranged such that the flap moves from said first position to said second position when the angle of attack of the incident airflow at said flap falls below a predefined angle for said at least one flap.

As the angle of attack of the incident airflow decreases, the upper surface of a wind turbine blade—which is normally the suction side of the blade—gradually becomes the pressure side of the blade. Accordingly, the lower blade surface gradually changes from being the pressure side to the new suction side. Based on the positioning of the flap at the leading edge of the blade, the flap can be arranged such that the flap opens once a particular portion of the flap is found in the suction zone of the airfoil profile. This can be when the angle of attack of the incident airflow falls below the predefined value for the flap's location.

Preferably, said at least one flap is arranged to move from said first position to said second position when the incident airflow at said flap has a negative angle of attack. In other arrangements, the flap may also open for a small positive angle of attack.

Preferably, the flap is arranged to maintain the lift coefficient above zero. The lift coefficient is preferably stabilised above zero for a substantial range of negative angles of attack.

Preferably, said wind turbine blade comprises a plurality of passively hinged flaps provided at said leading edge, said flaps spaced along a portion of the length of the blade.

The use of a series of spaced apart flaps along the length of the blade allows for the localised adjustment of the lift coefficient for sections of the blade.

Preferably, each of said plurality of flaps is operable to move from said first position to said second position when the angle of attack of the incident airflow at said flap falls below a predefined angle for said flap, wherein said pre-defined angle is determined by the location of the flap along the length of the blade.

As the lift coefficient varies with the airfoil profile, therefore different lift coefficients (and corresponding lift coefficient curves) may apply at different positions along the length of the blade, due to the variation in blade cross-section along the length of the blade. Thus, it may be advantageous to have a series of flaps provided along the leading edge of the blade, the flaps opening at different angles of attack, due to different requirements at the different locations.

In a preferred embodiment, the wind turbine blade comprises at least one inner section flap located at said leading edge between 20%-50% of the radial length of the blade from the root of the blade, said at least one inner flap arranged to move from said first position to said second position when the angle of attack of the incident airflow at said inner flap falls below 5°.

In a preferred embodiment, the wind turbine blade comprises at least one mid-section flap located at said leading edge between 50%-80% of the radial length of the blade from the root of the blade, said at least one mid-section flap arranged to move from said first position to said second position when the angle of attack of the incident airflow at said mid-section flap falls below 2°.

In a preferred embodiment, the wind turbine blade comprises at least one outer section flap located at said leading edge between 80%-100% of the radial length of the blade from the root of the blade, said at least one outer section flap arranged to move from said first position to said second position when the angle of attack of the incident airflow at said outer section flap falls below 0°.

In an alternate embodiment, said flap extends substantially along the length of the leading edge of the blade. The use of a single flap extending along the length of the blade allows for the lift coefficient of the entire blade to be instantly adjusted.

Preferably, said at least one flap comprises a first hinged end and a second free end, wherein said second free end is shaped to allow the ingress of incident air having an angle of attack less than a pre-defined angle into the area between said at least one flap and said blade body.

The use of a shaped end of the flap allows for air to enter between the flap and the body of the blade, so that the force of the air between the flap and the blade body forces the flap to open to the second position.

Preferably, said at least one flap comprises a shaped step, said step defining a recess between said flap and said blade body when in said first position.

The shaped step provides a recess which allows an aerodynamic force to build up in said recess behind the flap by the incident airflow, the force eventually acting to open said flap to the second position.

Preferably, the blade further comprises biasing means coupled to said flap. Preferably, said biasing means comprises a spring.

Preferably, the bias strength of said biasing means is selected to bias said flap in said first position when the angle of attack of incident air is above a pre-defined angle.

The use of biasing means allows for the flap to be maintained in the first position while the angle of attack is above a pre-defined angle (i.e. when the angle of attack is within the defined operational range for the wind turbine). Even though the incident air has an angle of attack above the pre-defined angle, airflow may enter into the area between the flap and the blade body. The strength of the biasing means will prevent unwanted opening of the flap from the first position to the second position while within the operational range of the turbine due to this relatively minor build up of air pressure beneath the flap. Thus, the aerodynamic profile of the wind turbine blade is largely unaffected by the flap when the angle of attack is positive.

Preferably, said blade body comprises an upper surface and a lower surface, wherein said flap comprises a hinge end and a free end, said hinge end hingedly coupled to said lower surface of said leading edge, and wherein when in said first position said free end extends adjacent a portion of said upper surface of said leading edge.

The flap is provided at the front of the wind turbine blade, at the leading edge of the blade. This allows the flap, when extended, to maximise the effect of the flap when extended in the second position for incident airflow having a negative angle of attack. The selection of the positioning of the flap at the leading edge can also allow for the selection of the particular angle of attack that the flap will open at, as this determines at what point the suction effect of the surrounding air pressure acts to open the flap to the second position.

Preferably, the flap is positioned such that a major portion of the flap is located on the lower surface side of the blade body. Accordingly, when the blade is in normal operation (i.e. when the incident airflow has an angle of attack above the pre-defined angle), the lower surface of the blade is the pressure side of the aerodynamic profile, thus closing the flap in the first position adjacent the surface of the blade body. When the angle of attack falls below a pre-defined angle (preferably specific to the flap arrangement), the lower surface of the blade is now the suction side of the aerodynamic profile, and/or the majority of the body of the flap is subject to suctional forces from the surrounding air pressure. Accordingly, the flap is ‘sucked’ open to the second position by the suction forces acting on that portion of the flap. Such a system may be also used in combination with biasing means and/or a shaped profile of the flap in order to open the flap during low wind conditions.

Preferably, said flap comprises a first hinged end and a second free end, wherein the length of said flap from said first hinged end to said second free end is chosen at ⅓ of the height of the wind turbine blade. In other embodiments, preferably, the length of said flap from said first hinged end to said second free end is at least 1/10 of the height of the wind turbine blade. Alternatively the length of said flap from said first hinged end to said second free end is at least 1/20 of the height of the wind turbine blade.

Preferably, said flap comprises a first hinged end and a second free end, wherein the length of said flap from said first hinged end to said second free end is 2 centimetres.

Preferably, said at least one flap is arranged to pivot 90° from said first position to said second position.

Preferably, at least one channel is defined in said blade body, wherein said at least one flap is accommodated in said channel when in said first position such that said flap is in register with the adjacent surface of said blade body when in said first position. I.e. the exterior surface of the flap when in the first position is in register (or flush) with the exterior surface of the wind turbine blade body adjacent said channel.

The use of a recessed channel allows for the flap to have no impact on the aerodynamic profile of the wind turbine blade when in the first position, i.e. during normal operation of the wind turbine.

Preferably, said flap is shaped to align with the aerodynamic profile of said blade when in said first position.

There is also provided a wind turbine comprising such a wind turbine blade.

An embodiment of the invention will now be described, by way of example only, with reference to the accompanying drawings, in which:

### BRIEF DESCRIPTION OF THE DRAWINGS

FIG. 1 is a cross-sectional view of a known wind turbine blade profile;

FIG. 2 is a plot of lift coefficient against angle of attack for a sample airfoil profile;

FIG. 3 is a cross-sectional view of a wind turbine blade according to the invention;

FIG. 4 is a cross-sectional view of the wind turbine blade of FIG. 2 when the flap is in the extended position; and

FIG. 5 is a plot of lift coefficient against angle of attack for the wind turbine blade of FIG. 3.

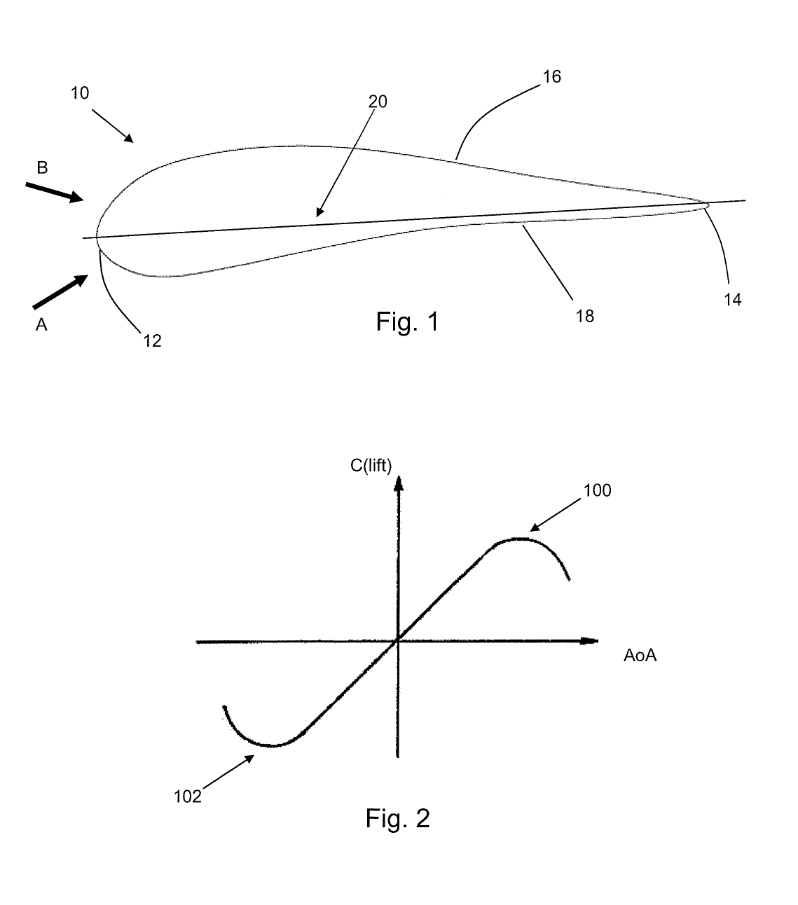

### DETAILED DESCRIPTION OF THE INVENTION

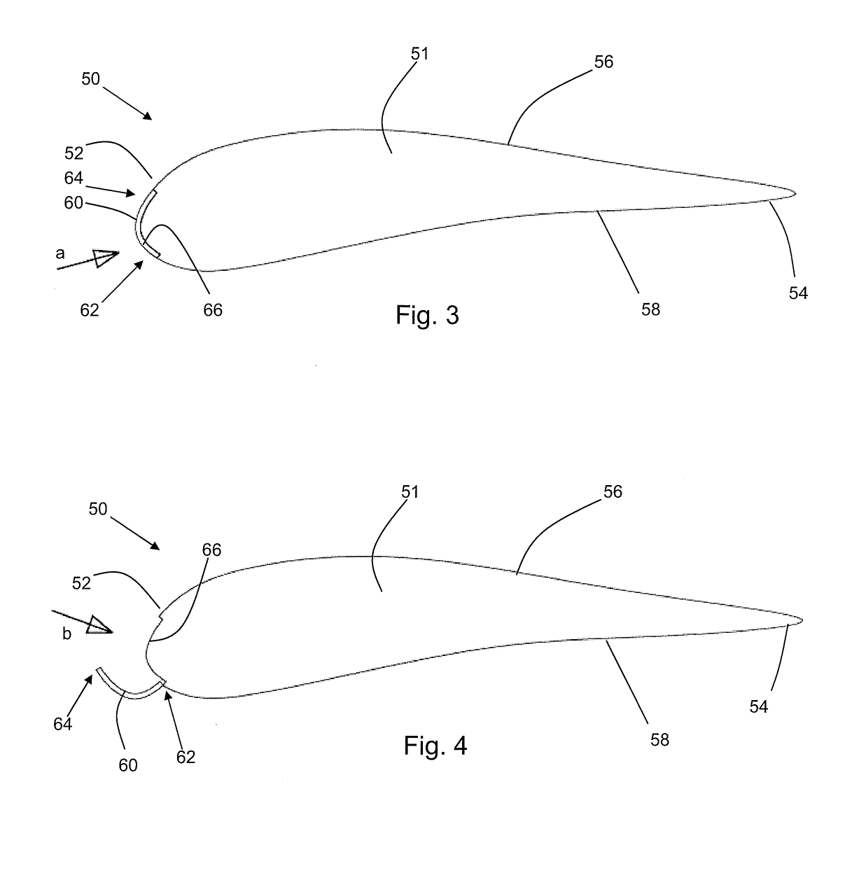

With reference to FIGS. 3 and 4, a wind turbine blade according to the invention is indicated generally at 50. The blade 50 comprises an airfoil-shaped blade body 51, having a leading edge 52 facing the incident wind and an opposed trailing edge 54. In normal operation, the upper surface of the blade 50 is referred to as the suction side 56 and the lower surface is referred to as the pressure side 58.

The blade 50 further comprises a flap 60 provided at the leading edge 52 of the blade body 51. The flap comprises a first hinged end 62 and a second free end 64, the flap 60 being hingedly coupled to the blade body 51 at said hinged end 62. The flap 60 is hinged on the lower pressure side 58 of the leading edge 52 of the blade body 51, the flap 60 being curvedly shaped so that the second free end 64 of the flap extends to the upper suction side 56 of the leading edge 52 of the blade body 51.

The flap 60 is arranged to hinge from a first position (seen in FIG. 3) wherein the flap 60 is provided adjacent the surface of the blade body 51, to a second position (seen in FIG. 4) wherein the free end 64 of the flap 60 extends away from the blade body 51.

A recess 66 is defined on the surface of the blade body 51 at the leading edge 52 of the blade, the flap 60 being provided in the recess 66. The recess 66 is arranged such that when the flap 60 is in the first position, the external surface of the flap 60 is in register with (or flush with) the exterior surface of the blade body 51 adjacent the recess 66. Such an arrangement means that the flap 60 becomes part of the streamlined airfoil shape of the wind turbine blade 50 when in the first position, and does not impact on the aerodynamic profile of the blade 50.

In use, the wind turbine blade 50 is mounted to a wind turbine tower wherein the leading edge 52 of the blade body 51 faces the oncoming incident wind. The flap 60 is arranged such that when the incident airflow has a substantially positive angle of attack (see arrow (a) of FIG. 3), the flap 60 is retained in the said first position. (I.e. when the angle that the incident airflow makes with the reference chord of the wind turbine blade airfoil at the leading edge of the airfoil is positive with respect to the lower, pressure side of the airfoil, the flap 60 is forced to close within the recess 66.)

When the wind direction changes and the incident wind has a negative angle of attack (see arrow (b) of FIG. 4), the flap 60 is forced to open to the said second position. As the angle of attack of the incident airflow gets progressively more negative, suction forces generated by the changing air pressure around the blade 50 are operable to force the flap 60 to pivot from the first position to the second position.

While the above Figures describe wherein the flap 60 opens when the incident airflow has a negative angle of attack, it will be understood that the flap 60 may be arranged such that the flap 60 will open for a relatively small positive angle of attack. Preferably, the flap 60 will open when the angle of attack of the incident airflow falls below a pre-defined angle. Preferably, said pre-defined angle is approximately +0-5°.

Once opened out, with the free end 64 extending away from the blade body 51, the flap 60 acts as a scoop and disrupts the airflow in the vicinity of the leading edge 52 of the blade 10. Accordingly, the aerodynamic profile of the wind turbine blade 50 is altered, due to the extended flap 60.

The flap 60 is designed so that, when extended, the aerodynamic profile of the blade 50 is altered such that the magnitude of the negative lift coefficient for the blade 50 with the extended flap 60 is reduced. Accordingly, the blade 10 is able to dynamically adjust its aerodynamic profile, and its associated lift coefficient curve, dependent on the current angle of attack of the incident airflow. As the magnitude of the negative lift coefficient is reduced, the wind turbine blade 50 experiences less negative lift due to swirling wind conditions. Accordingly, the difference in magnitude between the maximum positive lift coefficient and the maximum negative lift coefficient is reduced. Thus, stresses and strains on the blade 50 and the associated wind turbine tower structure are reduced, and the damage from fatigue loads due to sudden changes in incident wind angle of attack is minimised.

Preferably, the flap 60 is positioned such that the majority of the body of the flap 60 is located on the lower surface 58 side of the blade body 51. This means that the actuation of the flap 60 can be determined by the air pressure seen at the lower surface 58. During normal operation, the lower surface 58 of the blade 50 is the pressure side of the aerodynamic profile, and such relatively high air pressure acts to close the flap 60 in the first position adjacent the surface of the blade body 51. However, when the angle of attack of the incident airflow falls below a pre-defined angle, that portion of the flap 60 provided on the lower surface 58 of the blade 50 is now at the suction side of the aerodynamic profile, such that the majority of the body of the flap 60 is subject to suctional forces from the surrounding air pressure. Accordingly, the flap 60 is ‘sucked’ open to the second position by the suction forces acting on that portion of the flap 60.

It will be understood that the flap 60 may additionally or alternatively be forced to open from said first position to said second position by the ingress of airflow between the flap 60 and the blade body 51, the aerodynamic force thereby generated acting to force the flap 60 to open.

It will be understood that a space may be provided between the edge of free end 64 of the flap 60 and the edge of the channel 66, so that airflow may easily enter between the flap 60 and the blade body 51 to force open the flap 60. Furthermore, the free end 64 of the flap 60 may be dimensioned or shaped to channel airflow into the area beneath the flap 60, particularly when said airflow has a highly negative angle of attack.

Preferably, the free end 64 of the flap is shaped, and comprises angled channels or an angled surface (not shown) which allows air to enter into the space between the flap 60 and the body of the blade 50, when the flap 60 is in the first position. The free end 64 is shaped to facilitate the easy ingress of air having an angle of attack less than the pre-defined angle for that flap 60, while preventing easy ingress of air having an angle of attack greater than said pre-defined angle. As air enters into the area beneath the flap 60, the air pressure behind the flap 60 can build up until the collected air pressure forces the opening of the flap 60 to the second position. Such shaping of the free end 64 allows for the opening of the flap 60 to be controlled by the angle of attack of the incident airflow.

In some embodiments, the free end 64 may be shaped to define a step end (not shown) at said free end 64, which defines a recess between the flap 60 and the body of the blade 50 when said flap 60 is in said first position. This recess allows for airflow to pool and circulate behind the flap 60, so that the collected airflow can build up sufficient aerodynamic pressure behind the flap 60 to force said flap 60 to open to said second position.

The flap 60 may comprise biasing means, e.g. a spring device, which acts to bias the flap 60 into said first position against the blade body 51. The biasing strength of such spring means can be selected so that the flap 60 is retained against the blade body 51 until the incident airflow between the flap 60 and the channel 66 reaches a pre-defined strength in order to force the flap 60 open. Such a system may prevent undesired opening of the flap 60 when the incident airflow is at a relatively low force and/or subject to continuous changes.

As can be seen from FIGS. 3 and 4, flap 60 is shaped to conform with the profile of the leading edge 52 of the wind turbine blade 50. It will be understood that any suitable profile of flap 60 may be used.

The flap 60 can be selected to cover approximately ⅓ of the leading edge 52 of the wind turbine blade 50, i.e. that the length of the flap 60 is approximately ⅓ of the height of the blade 50. For a standard blade having a height of approximately 6 centimetres, this can result in a 2 centimetre long flap. It will be understood that the flap may be selected at any suitable length, preferably at least 1/20 of the height of the blade, further preferably 1/10 of the height of the blade.

The flap 60 may be provided as one long single flap, extending along substantially the entire length of the blade 50.

In a preferred embodiment, the blade 50 comprises a series of smaller flaps spaced along the length of the blade 50, at the leading edge 52 of the blade 50. Each flap 60 covers a portion of the length of the leading edge 52 of the blade 50. Such smaller separated flaps allow for the localised adjustment of lift coefficients at different points along the blade body 51.

As the lift coefficient depends in part on the aerodynamic cross-section of the blade body 51 seen when moving along the length of the blade 50, accordingly it is preferable to have a series of flaps operable to open at different angles of attack of incident airflow, depending on design requirements.

It is preferable that any flaps 60 provided within an inner section of the length of the blade (e.g. between 20%-50% of the radial length of the wind turbine blade 50, measured from the root of the blade) are arranged to open from the first position to the second position when the angle of attack of the incident airflow at this section falls below 5°.

Furthermore, it is preferable that any flaps 60 provided within an middle section of the length of the blade (e.g. between 50%-80% of the radial length of the wind turbine blade 50, measured from the root of the blade) are arranged to open from the first position to the second position when the angle of attack of the incident airflow at this section falls below 2°.

Also, it is preferable that any flaps 60 provided within an outer section of the length of the blade (e.g. between 80%-100% of the radial length of the wind turbine blade 50, measured from the root of the blade) are arranged to open from the first position to the second position when the angle of attack of the incident airflow at this section falls below 0°.

It will be understood that any number of flaps 60 may be used, having any suitable angles which determine the deployment of the particular flap 60.

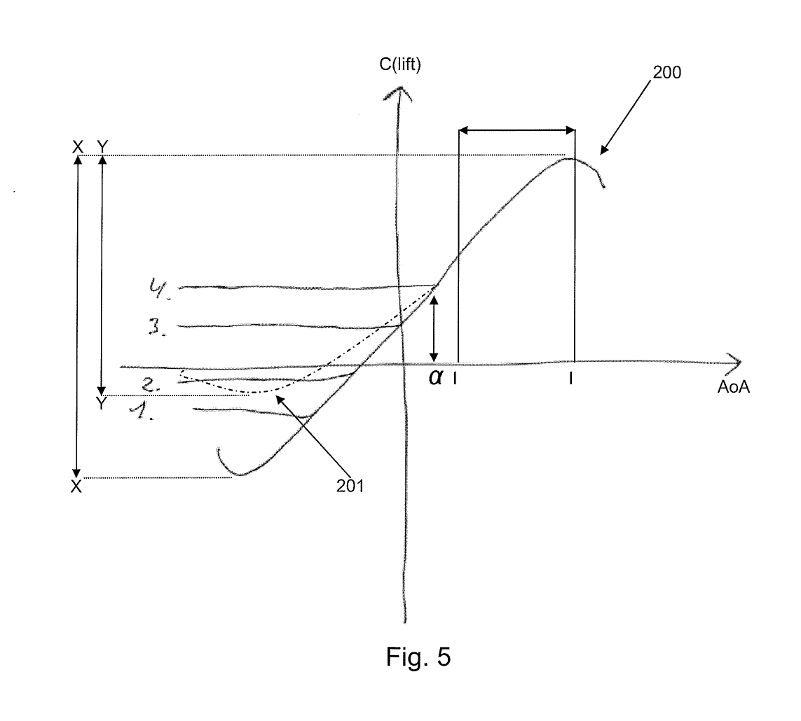

With reference to FIG. 5, a sample plot (indicated at 200) of lift coefficient (C(lift)) against angle of attack (AoA) is shown for a standard wind turbine blade profile. Such a curve 200 may apply for the general airfoil profile shown for the wind turbine blade 50, when the flap 60 is in said first position (i.e. when flap 60 does not interfere with the aerodynamic profile of the blade 50). As can be seen from FIG. 5, such a standard profile may have a substantial negative lift coefficient (i.e. the lower maximum of the curve). For the standard profile, the difference between the maximum negative lift coefficient and the maximum positive lift coefficient (indicated by X-X) is substantial, and results in relatively high fatigue loads produced in the structure of the blade 50 and in the larger wind turbine structure.

For the plot shown, the flap 60 is configured such that the flap 60 will open from said first position to said second position when the angle of attack of incident airflow falls below the pre-defined angle a (i.e. corresponding to point 4 on the curve.) At this point, the flap 60 deploys, and effectively changes the aerodynamic profile of the blade 50 at the location of the flap 60. Accordingly, the lift coefficient curve 200 is altered for this location, with a reduction in the magnitude of the negative lift coefficient seen at this point along the blade length (indicated by the dashed line 201). Any increase of the angle of attack of the incident airflow above the predefined angle a will cause the flap 60 to close to said first position, returning to the original lift coefficient curve 200. Accordingly, the difference in magnitude between the positive and negative lift coefficients of the blade 50 has been effectively reduced, indicated by the line Y-Y. Reducing this difference from X-X to Y-Y results in a corresponding reduction in the fatigue loads which are generated in the blade 50.

The normal operational range of a wind turbine having such a blade 50 is indicated in the section I-I, showing the range of angle of attack of incident airflow that is predicted for normal operation of the turbine. Accordingly, the blade 50 is designed such that the flap 60 will deploy when the angle of attack drops outside of this operational range. Dependent on how broad the operational range of the wind turbine is predicted to be, the flap 60 may be arranged to operate at any suitable pre-defined angle outside of this range. For example, the flap may open at a small positive angle of attack (point 4), the flap may open for any negative angle of attack (i.e. the point on the curve where AoA =0, point 3), a small negative angle of attack (point 2), or a large negative angle of attack (point 1).

The use of a wind turbine blade as described above in a wind turbine provides several advantages over and above the prior art: the system is unpowered/passive, and does not require relatively complicated sensor systems or actuation devices; due to the simplicity of the design, reliability can be relatively higher than other prior art systems; the system of the invention may be easily retrofitted to existing turbine blades; and the system can be relatively lightweight, and does not seriously affect normal operation of a wind turbine blade.

The invention is not limited to the embodiment described herein, and may be modified or adapted without departing from the scope of the present invention.

What is claimed is:

1. A wind turbine blade having an aerodynamic profile, the blade comprising a blade body having a leading edge and a trailing edge, the blade further comprising at least one passively hinged flap provided along a section of said leading edge, said flap arranged to hinge from a first position, wherein said flap is positioned adjacent the surface of said blade body, to a second position, wherein said flap projects from said blade body, wherein said at least one flap is arranged such that when in said second position said flap is operable to reduce the magnitude of the negative lift coefficient of the wind turbine blade at said at least one flap.

2. The wind turbine blade of claim 1, wherein said at least one flap is actuated to move from said first position to said second position by the force of the air pressure of the incident airflow at said at least one flap.

3. The wind turbine blade of claim 1, wherein said at least one flap is arranged such that the flap is operable to move from said first position to said second position when the angle of attack of the incident airflow at said flap falls below a predefined angle for said at least one flap.

4. The wind turbine blade of claim 1, wherein said wind turbine blade comprises a plurality of passively hinged flaps provided at said leading edge, said flaps spaced along a portion of the length of the blade.

5. The wind turbine blade of claim 1, wherein said wind turbine blade comprises a plurality of passively hinged flaps provided at said leading edge, said flaps spaced along a portion of the length of the blade, wherein each of said plurality of flaps is operable to move from said first position to said second position when the angle of attack of the incident airflow at said flap falls below a pre-defined angle for said flap, wherein said pre-defined angle is determined by the location of the flap along the length of the blade.

6. The wind turbine blade of claim 1, wherein said blade body comprises an upper surface and a lower surface, wherein said flap comprises a hinge end and a free end, said hinge end hingedly coupled to said lower surface of said leading edge, and wherein when in said first position said free end extends adjacent a portion of said upper surface of said leading edge.

7. The wind turbine blade of claim 1, wherein said at least one flap comprises a first hinged end and a second free end, wherein said second free end is shaped to allow the ingress of incident air having an angle of attack less than a pre-defined angle into the area between said at least one flap and said blade body.

8. The wind turbine blade of claim 1, wherein said blade further comprises biasing means coupled to said flap, wherein the bias strength of said biasing means is selected to bias said flap in said first position when the angle of attack of the incident air is above a pre-defined angle.

9. The wind turbine blade of claim 1, wherein at least one channel is defined in said blade body, wherein said at least one flap is accommodated in said channel when in said first position such that said flap is in register with the adjacent surface of said blade body when in said first position.

10. A wind turbine comprising a wind turbine blade having an aerodynamic profile, the blade comprising a blade body having a leading edge and a trailing edge, the blade further comprising at least one passively hinged flap provided along a section of said leading edge, said flap arranged to hinge from a first position, wherein said flap is positioned adjacent the surface of said blade body, to a second position, wherein said flap projects from said blade body, wherein said at least one flap is arranged such that when in said second position said flap is operable to reduce the magnitude of the negative lift coefficient of the wind turbine blade at said at least one flap.
